(19) United States
(12) Patent Application Publication
(10) Pub. No.: US 2026/0101101 A1
(43) Pub. Date: Apr. 9, 2026

(54) DEVICES AND METHODS FOR OBJECTIVE LENS ASSEMBLY INSTALLATION

(71) Applicant: IDEXX Laboratories, Inc., Westbrook, ME (US)

(72) Inventor: Mark Dumont, Scarborough, ME (US)

(73) Assignee: IDEXX Laboratories, Inc., Westbrook, ME (US)

(21) Appl. No.: 19/241,715

(22) Filed: Jun. 18, 2025

Related U.S. Application Data
(60) Provisional application No. 63/702,679, filed on Oct. 3, 2024.

(51) Int. Cl. H04N 23/55; G02B 7/02

(52) U.S. Cl. CPC H04N 23/55; G02B 7/022; G02B 7/026

(57) ABSTRACT

A tool for securing an objective lens assembly to an imaging system body. The tool includes a base member including an objective lens assembly connection portion and a wrench connection portion. The wrench connection portion is configured to be coupled to a wrench. The tool also includes a rotating arm pivotally coupled to the base member at a pivot portion of the rotating arm. The rotating arm includes a locking portion selectively engageable with the base member. The tool further includes a base member engagement pad on an inner surface of the base member, wherein the base member engagement pad contacts an objective lens assembly positioned at least partially within the tool. The tool further includes a rotating arm engagement pad positioned on an inner surface of the rotating arm, wherein the rotating arm engagement pad contacts the objective lens assembly positioned at least partially within the tool.

### CROSS-REFERENCE TO RELATED APPLICATIONS

This application claims the benefit of co-pending U.S. Provisional Patent Application Ser. No. 63/702,679, filed Oct. 3, 2024, which is hereby incorporated by reference in its entirety.

### FIELD

The present disclosure relates to tools and methods for securing an objective lens to an imaging system body.

### BACKGROUND

Testing and imaging of biological samples is often done using an imaging system. Quality images are important in imaging biological samples because they enable accurate and reliable data interpretation. An objective lens assembly is a lens system responsible for forming images of the biological sample and is typically among the most expensive components of the imaging system. Misalignment of the objective lens assembly within the imaging system can result in unclear images and/or a reduction in image quality.

The imaging system body typically has a threaded connection configured to mate with a threaded connection on the objective lens assembly. To secure the objective lens assembly to the imaging system body, the objective lens assembly is typically manually torqued, for example, using of a strap wrench. During installation, the rotational axis of the objective lens assembly is typically at or near the center of the objective lens assembly. A strap wrench applies torque at or near the exterior surface of the objective lens assembly. Thus, when installing the objective lens assembly with a strap wrench, the torque is applied out of axial alignment with the rotational axis of the lens assembly. Additionally, this method of installation is prone to over-torquing the objective lens assembly. Further, tension of the strap on the objective lens assembly, which impacts frictional forces applied to the objective lens assembly, can vary between strap wrenches and/or operators.

### SUMMARY

In an example, a tool for securing an objective lens assembly to an imaging system body is disclosed. The tool includes a base member comprising an objective lens assembly connection portion and a wrench connection portion, wherein the wrench connection portion is configured to be coupled to a wrench. The tool also includes a rotating arm pivotally coupled to the base member at a pivot portion of the rotating arm, the rotating arm comprising a locking portion selectively engageable with the base member. The tool additional includes a base member engagement pad on an inner surface of the base member, wherein the base member engagement pad contacts an objective lens assembly positioned at least partially within the tool. The tool further includes a rotating arm engagement pad positioned on an inner surface of the rotating arm, wherein the rotating arm engagement pad contacts the objective lens assembly positioned at least partially within the tool.

In another example, method of securing an objective lens assembly to an imaging system body is disclose. The method includes positioning at least a portion of an objective lens assembly within an objective lens assembly connection portion of a base member, wherein the base member comprises a base member engagement pad on an inner surface of the base member, and wherein the base member engagement pad contacts the objective lens assembly. The method further includes locking a locking portion of a rotating arm to the base member such that a rotating arm engagement pad, positioned on an inner surface of the rotating arm, contacts the objective lens assembly, wherein the rotating arm is pivotally coupled to the base member at a pivot portion of the rotating arm. The method additionally includes rotating the base member, the rotating arm, and the objective lens assembly via wrench coupled to a wrench connection portion of the base member.

The features, functions, and advantages that have been discussed can be achieved independently in various examples or may be combined in yet other examples. Further details of the examples can be seen with reference to the following description and drawings.

### BRIEF DESCRIPTION OF THE DRAWINGS

Various aspects and features of the present disclosure are described hereinbelow with reference to the drawings wherein:

FIG. 1A illustrates a tool for securing an objective lens assembly to an imaging system body, according to an example embodiment.

FIG. 1B illustrates a tool for securing an objective lens assembly to an imaging system body, according to an example embodiment.

FIG. 1C illustrates an exploded view of a tool for securing an objective lens assembly to an imaging system body, according to an example embodiment.

FIG. 2A illustrates a tool securing an objective lens assembly to an imaging system body, according to an example embodiment.

FIG. 2B illustrates a tool securing an objective lens assembly to an imaging system body, according to an example embodiment.

FIG. 2C illustrates a tool securing an objective lens assembly to an imaging system body, according to an example embodiment.

FIG. 3 illustrates a method, according to an example embodiment.

### DETAILED DESCRIPTION

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

Historically, an operator manually secures an objective lens assembly to an imaging system body using of a strap wrench. During installation, the rotational axis of the objective lens assembly is typically at or near the center of the objective lens assembly. A strap wrench applies torque to an axis of rotation at or near the exterior surface of the objective lens assembly. Thus, when installing the objective lens assembly with a strap wrench, the torque is applied out of axial alignment with the rotational axis of the lens assembly. Additionally, this method of installation is prone to over-torquing the objective lens assembly. Further, tension of the strap on the objective lens assembly, which impacts frictional forces applied to the objective lens assembly, can vary between strap wrenches and/or operators.

Embodiments of the present disclosure address these issues. For instance, example tools and associated methods described herein facilitate securing an objective lens assembly to an imaging system body in a repeatable manner that applies consistent and controlled contact pressure at multiple areas around the objective lens assembly. To do so, an example tool includes a base member, configured to receive at least a portion of the objective lens assembly, and a rotating arm including a lock to secure the objective lens assembly and the rotating arm around the objective lens assembly. Together the base member and rotating arm surround the objective lens assembly.

Both the base member and the rotating arm include engagement pads on inner surfaces of the tool, which contact the surface of the objective lens assembly. The engagement pads protrude inward from the inner surfaces of the tool, restricting other components of the tool from contacting the objective lens assembly. The engagement pads apply surface pressure on the objective lens assembly which is distributed throughout each of the engagement pads during installation. In this manner, surface pressure is applied at different areas on the surface of the objective lens assembly. The engagement pads can include materials having coefficients of friction high enough to grip and rotate the objective lens assembly as the tool rotates, but low enough to prevent over-torquing of the objective lens assembly. Additionally, the engagement pads can include materials which prevent damaging or marring the objective lens assembly during installation.

Further, an example tool applies torque from a position that is in axial alignment with the rotational axis of the objective lens assembly. For instance, an example tool can include a wrench connection portion in an upper portion of an L-shaped member of the base member. The wrench connection portion is positioned above the objective lens assembly. When the objective lens assembly is positioned within the tool, the wrench connection portion is positioned above center of the objective lens assembly and, thus, is in axial alignment with the rotational axis of the objective lens assembly. A torque wrench can then couple to the wrench connection portion and apply torque in axial alignment of the rotational axis of the objective lens assembly.

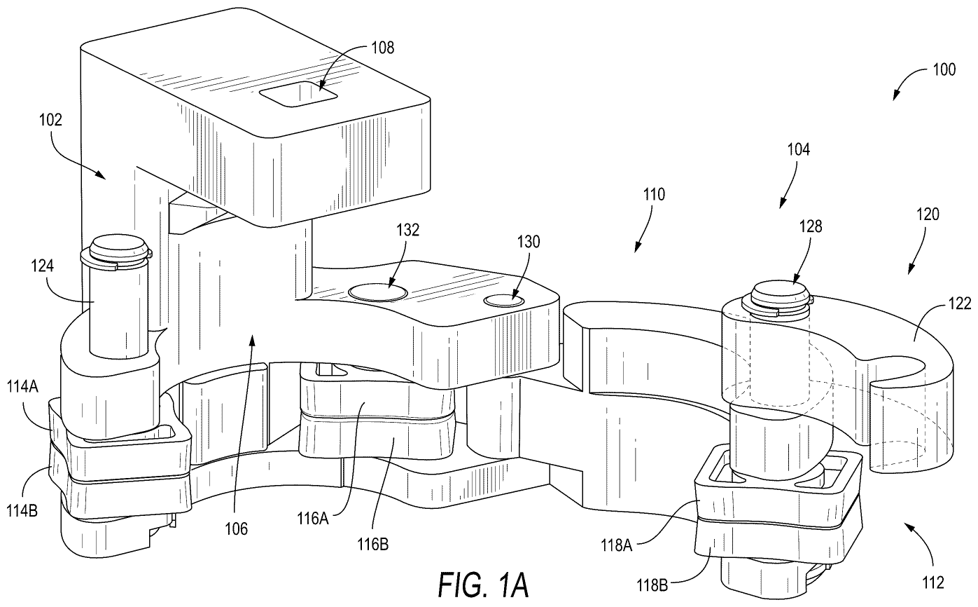

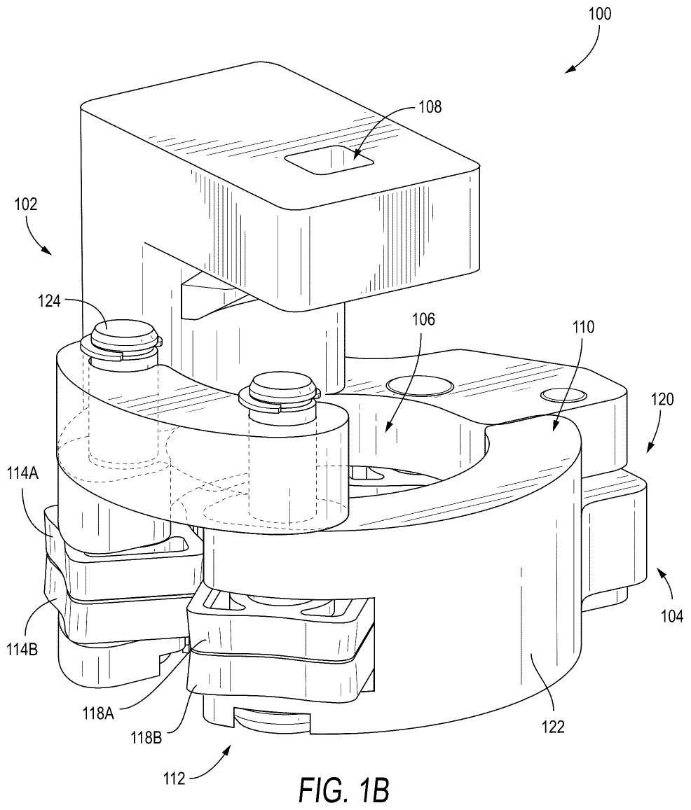

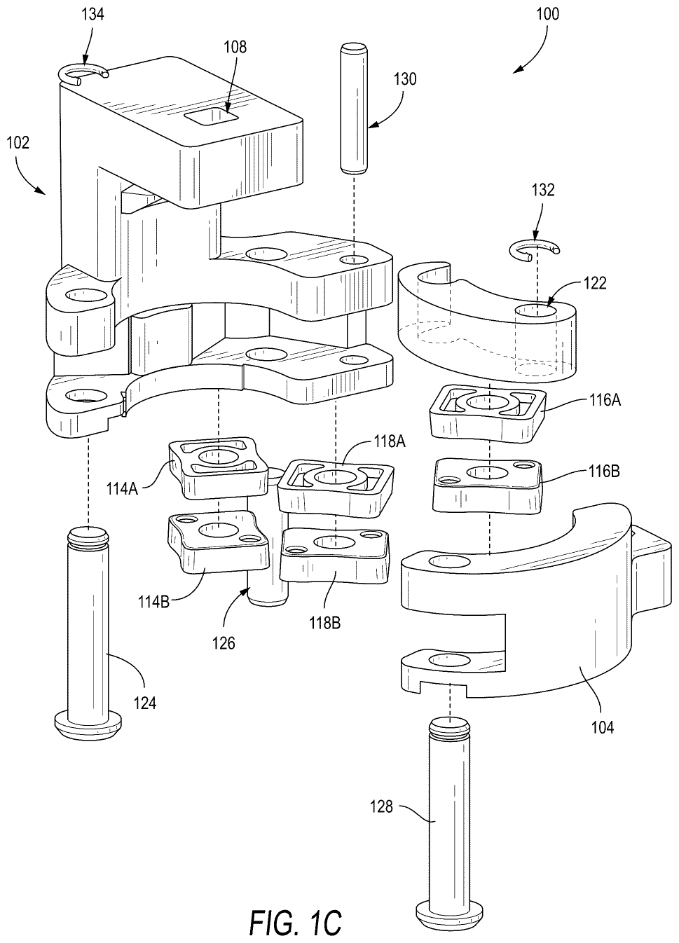

Now referring to the Figures, FIGS. 1A-1B illustrate a tool 100 for securing an objective lens assembly to an imaging system body, according to an example embodiment. An example tool 100 includes a base member 102 and a rotating arm 104. The rotating arm 104 is pivotally coupled to the base member 102 at a pivot portion 110 of the rotating arm 104. FIG. 1A illustrates the tool 100 with the rotating arm 104 in an open position and FIG. 1B illustrates the tool 100 with the rotating arm 104 in a closed position.

The base member 102 includes an objective lens assembly connection portion 106 and a wrench connection portion 108. In example implementations, the base member 102 includes an L-shaped member. In examples, the objective lens assembly connection portion 106 is in or is adjacent to a lower portion of the L-shaped member and the wrench connection portion 108 is in the horizontal portion of the L-shaped member.

The base member 102 includes one or more base member engagement pads 114A, 114B, 116A, 116B on or adjacent to an inner surface of the base member 102. During installation, the objective lens assembly makes contact with the base member engagement pads 114A, 114B, 116A, 116B. To facilitate contact with the objective lens assembly, the base member engagement pads 114A, 114B, 116A, 166B protrude from an inner surface of the base member 102. In this manner, other components of the base member 102 are prevented from contacting the objective lens assembly. This helps protect the objective lens assembly from becoming damaged or marred during installation.

In examples, the base member 102 includes a first set of base member engagement pads 114A-114B and a second set of base member engagement pads 116A-116B, as shown in FIGS. 1A-1B. In this configuration, the first set of base member engagement pads 114A-114B contact the objective lens assembly at a first area of the objective lens assembly when the objective lens assembly is positioned at least partially within the tool 100. The second set of base member engagement pads 116A-116B contact the objective lens assembly at a second area of the objective lens assembly when the objective lens assembly is at least partially within the tool 100. In some examples, the first area of the objective lens assembly and the second area of the objective lens assembly are radially spaced apart from one another (e.g., when considering a radius from the center point of a horizontal cross-section of the objective lens assembly to the exterior surface of the objective lens assembly). For example, the first area and the second area may be between 90-150 degrees from one another. In some examples, the base member 102 includes fewer (e.g., 1, 2, or 3) base member engagement pads or more (e.g., 5, 6, 7, 8, etc.) base member engagement pads than those shown in the example configuration in FIGS. 1A-1B. Many example configurations are possible.

In some example implementations, the respective surfaces of the base member engagement pads can include materials having a coefficient of friction which is high enough to facilitate rotation of the objective lens assembly as the tool 100 rotates, but low enough to prevent over-torquing the objective lens assembly. For instance, in examples, the respective surfaces of the base member engagement pads 114A, 114B, 116A, 116B have a coefficient of friction such that a torque value of the objective lens assembly does not exceed a maximum desired torque value. For instance, in some examples a maximum desired torque value may be between 0.5-1.5 ft-lb. In this manner, the materials would lose their grip or slip once the objective lens assembly 202 is installed.

Further, the surfaces of the base member engagement pads 114A, 114B, 116A, 116B can include materials that will prevent damage or marring of the object lens assembly during installation. For instance, the base member engagement pads 114A, 114B, 116A, 116B can include one or more of the following: (i) elastomers; (ii) silicone; (iii) rubber; and (iv) plastic. Other example materials are possible.

Further, in example implementations, the base member engagement pads 114A, 114B, 116A, 116B can be fabricated by means casting and/or molding. These processes allow for angled walls for part release. For instance, in examples, a perimeter of the top portion of base member engagement pads 114A and 116A may be greater than the perimeter of the bottom portion of the respective base member engagement pads 114A and 116A. And, a perimeter of the bottom portion of base member engagement pads 114B and 116B may be greater than a perimeter of the top portion of the respective base member engagement pads 114B and 116B. In this manner, each pair of base member engagement pads (i.e., 114A and 114B, and 116A and 116B) establishes two points of contact with the objective lens assembly.

In some examples, the base member engagement pads 114A, 114B are coupled to the tool 100 by way of a pin 124. The pin 124 can extend from the surface of the base member 102, as shown in FIGS. 1A-1B. Similarly, base member engagement pads 116A, 116B can be coupled to the tool 100 by way of pin 132. In this manner, the base member engagement pads 114A, 114B, 116A, 116B can rotate about the respective pins 124, 132 to align with and grip the objective lens assembly during installation. In some examples, the base member engagement pads 114A, 114B, 116A, 116B may be adhered to the inner surface of the base member 102.

As noted above, in examples, the wrench connection portion 108 is positioned on an upper portion of an L-shaped member, such that the wrench connection portion 108 is above the objective lens assembly during installation. During installation, the wrench connection portion 108 does not contact the objective lens assembly, preventing damage or marring of the objective lens assembly. The wrench connection portion 108 is compatible with a torque wrench. More particularly, the wrench connection portion 108 is configured to receive at least a portion of a drive head of a torque wrench. When inserted into the wrench connection portion 108, rotation of the drive head of the toque wrench rotates the tool 100.

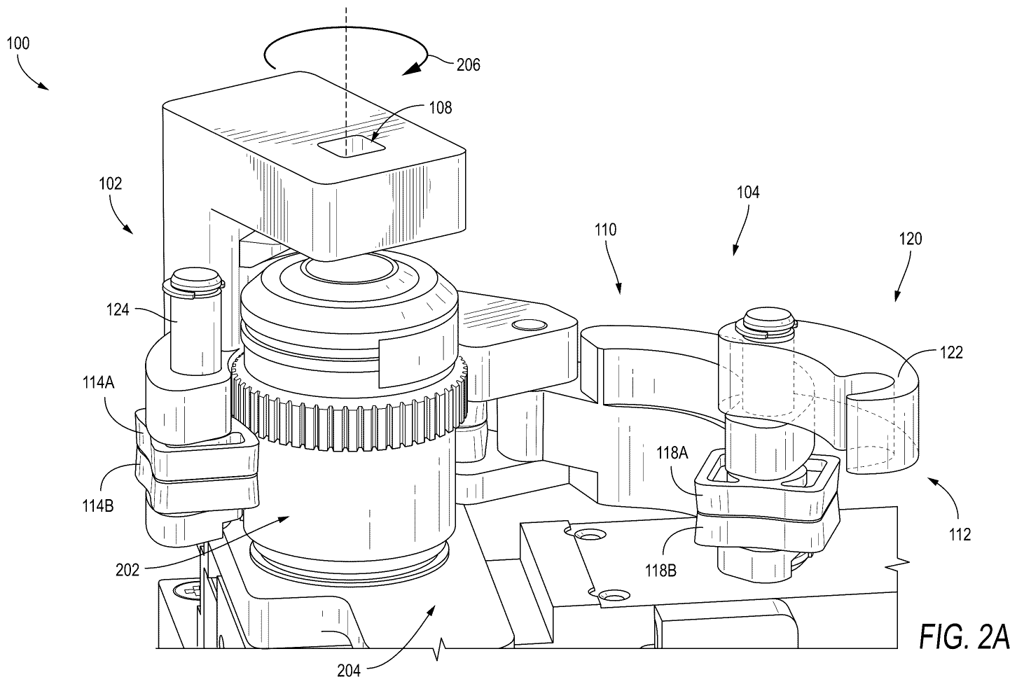

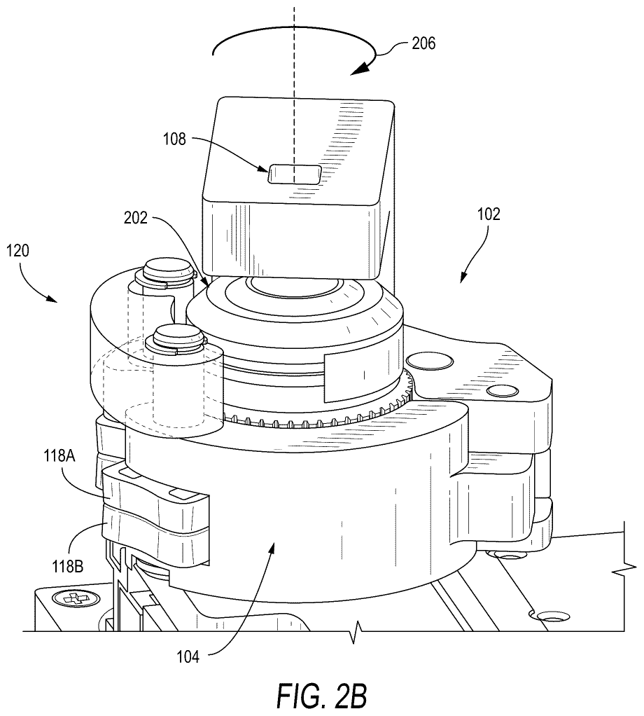

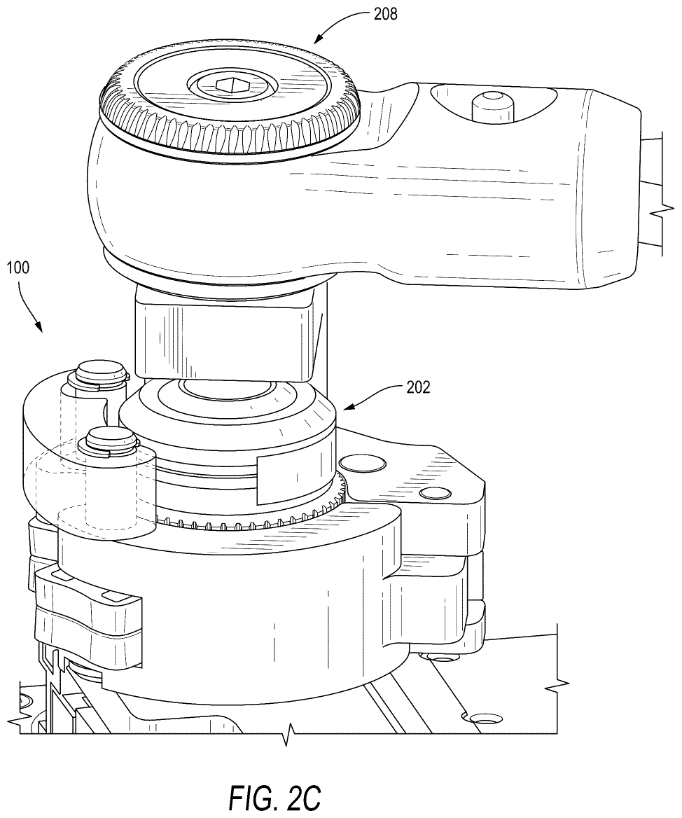

When the objective lens assembly is at least partially within the tool, the wrench connection portion 108 is aligned with a rotational axis of the objective lens assembly (as shown in FIG. 2A). In this manner, the drive head of the torque wrench is axially aligned with the rotational axis of the objective lens assembly during installation. This helps prevent misalignment of the objective lens assembly during installation.

As noted above, the tool 100 in includes a rotating arm 104 pivotally coupled to the base member 102. The rotating arm 104 includes a pivot portion 110 and a locking portion 112. The rotating arm 104 is pivotally coupled to the base 102 at the pivot portion 110. The rotating arm 104 is configured to rotate between an open position, shown in FIG. 1A, and a closed position, as shown in FIG. 1B. This enables a user to position the base member 102 adjacent to the objective lens assembly while the rotating arm 104 is in an open position and then pivot the rotating arm 104 to the closed position for installation. In some examples, the rotating arm 104 is coupled to the base member 102 via a pin 130. Other pivoting mechanisms are possible, such as a hinge.

In example embodiments, the rotating arm 104 includes one or more rotating arm engagement pads 118A, 118B. During installation, the objective lens assembly contacts the rotating arm engagement pads 118A, 118B. To facilitate contact with the objective lens assembly, the rotating arm engagement pads 118A, 118B protrude from an inner surface of the rotating arm 104. In this manner, other components of the rotating arm 104 are prevented from contacting the objective lens assembly. This helps prevent damage or marring of the objective lens assembly during installation.

The rotating arm engagement pads 118A, 118B contact the object lens assembly at a third area of contact on the surface of objective lens assembly, in addition to first area and the second area corresponding to the base member engagement pads 114A, 114B and base member engagement pads 116A, 116B, respectively. In some examples, the first, second, and third areas of the objective lens assembly are radially spaced apart from one another (e.g., when considering a radius from the center point of a horizontal cross-section of the objective lens assembly to the exterior surface of the objective lens assembly). In some examples, the first area of the objective lens assembly and the third area of the objective lens assembly are between 90-150 degrees from each other. Additionally or alternatively, in some examples, the second area of the objective lens assembly and the third area of the objective lens assembly are between 90-150 degrees from each other. Many configurations are possible.

In some example implementations, the respective surfaces of the rotating arm engagement pads 118A, 118B can include materials having a coefficient of friction which is high enough to facilitate rotation of the objective lens assembly as the tool 100 rotates, but low enough to prevent over-torquing the objective lens assembly. For instance, in examples, the respective surfaces of the rotating arm engagement pads 118A, 118B have a coefficient of friction such that a torque value of the objective lens assembly does not exceed a maximum desired torque value. For instance, in some examples a maximum desired torque value may be between 0.5-1.5 ft-lb.

Further, the surfaces of the rotating arm engagement pads 118A, 118B can include materials that will prevent damage or marring of the object lens assembly during installation. For instance, the rotating arm engagement pads 118A, 118B can include one or more of the following: (i) elastomers; (ii) silicone; (iii) rubber; and (iv) plastic. Other example materials are possible.

Further, in example implementations, the rotating arm engagement pads 118A, 118B can be fabricated by means casting and/or molding. These processes allow for angled walls for part release. For instance, in examples, a perimeter of the top portion of rotating arm engagement pads 118A may be greater than the perimeter of the bottom portion of rotating arm engagement pad 118A. And, a perimeter of the bottom portion of rotating arm engagement pads 118B may be greater than a perimeter of the top portion of the rotating arm engagement pads 118B. In this manner, the pair of rotating arm engagement pads 118A, 118B establishes two points of contact with the objective lens assembly In some examples, rotating arm engagement pads 118A, 118B are coupled to the rotating arm 104 by way of a pin 128. The pin 128 can be positioned in the rotating arm 104 and extend from the surface of the rotating arm 104. In this manner, the rotating arm engagement pads 118, 118B can rotate about the pin 128 to align with and grip the surface of the objective lens assembly during installation. In some examples, the base member engagement pads may be adhered to the base member 102, for example at the inner surface of the base member 102 or any other suitable surface of the base member 102.

The locking portion 112 of the rotating arm 104 includes a mechanism to lock or secure the rotating arm 104 to the base member 102. For instance, in some example embodiments, the locking portion 112 includes a lock 120. In some examples, the lock 120 includes a swing arm 122, as shown in FIGS. 1A-2C. In these examples, the lock 120 can be pivotally coupled to the rotating arm 104 by way of a pin 128. In some examples, the rotating arm engagement pads 118A, 118B and the lock 120 may be coupled to the rotating arm 104 by way of the same pin 128, as shown in FIGS. 1A-2C, however other configurations are possible.

The lock 120 is configured to selectively engage with the base member 102. For instance, in examples, the base member 102 can include a pin 124. When the rotating arm 104 is in the closed position, as shown in FIG. 1B, the lock 120 can be coupled to the pin 124 on the base member 102 to secure the rotating arm 104 to the base member 102. This helps to secure the tool 100 around the objective lens assembly during use. Once the objective lens assembly is secured to the imaging system body, the lock 120 can then be selectively disengaged from the pin 124. The rotating arm 104 can then be returned to the open position, as shown in FIG. 1A, to remove the tool 100 from the objective lens assembly.

Other examples configurations are possible. For instance, in some examples, the base member 102 can include a lock configured to selectively engage with the rotating arm 104 (for example, by way of a pin). Further, other types of locks and securing mechanisms can be utilized (e.g., a clamp, a clip, a button, etc).

Now referring to FIG. 1C, which illustrates an exploded view of the tool 100. In addition to the components and features of the tool 100 described with respect to FIGS. 1A-1B, in some examples the tool 100 can additionally include a retaining ring 132 coupled to pin 128. The retaining ring 132 prevents dislodging and/or misalignment of pin 128 with respect to the rotating arm 104 during use. Similarly, the tool 100 can include a retaining ring 134 coupled to pin 124. The retaining ring 134 prevents dislodging and/or misalignment of pin 124 with respect to the base member 102 during use.

Now referring to FIGS. 2A-2C, which illustrate the tool 100 during an example installation of an objective lens assembly. To begin, FIG. 2A shows the tool 100 with the rotating arm 104 in an open position. With the rotating arm 104 in the open position, the tool 100 can be positioned around the objective lens assembly 202 before the objective lens assembly is secured to the imaging system body 204. Namely, the objective lens assembly connection portion 106 is placed around to the objective lens assembly so that the base member engagement pads 114A, 114B, 116A, 116B contact the objective lens assembly 202. In this position, other components of the base member do not contact the objective lens assembly 202. In other words, the base member engagement pads 114A, 114B, 116A, 166B are the only portions of the base member 102 in contact with the objective lens assembly 202. Further, in this position, the wrench connection portion 108 is above the objective lens assembly 202. More particularly, the wrench connection portion 108 is axially aligned with a rotational axis 206 of the objective lens assembly.

As shown in FIG. 2A, the first set of base member engagement pads 114A, 114B contacts the objective lens assembly 202 at a first area of the objective lens assembly and the second set of base member engagement pads 116A, 116B contacts the objective lens assembly 202 at a second area of the objective lens assembly. The first area and the second area are spaced apart from one another (e.g., when considering a radius from the center point of a horizontal cross-section of the objective lens assembly to the exterior surface of the objective lens assembly). In some example configurations, the first area of the objective lens assembly and the second area of the objective lens assembly are between 90-150 degrees from each other.

Once the tool 100 is positioned on the objective lens assembly 202, the rotating arm 104 can be moved to the closed position as shown in FIG. 2B. In this position, the tool 100 surrounds the objective lens assembly 202. Once the rotating arm 104 is in the closed position, the rotating arm engagement pads 118A, 118B contact the objective lens assembly 202 at a third area on the surface of the objective lens assembly 202. In some example configurations, the first area of the objective lens assembly and the third area of the objective lens assembly are between 90-150 degrees from each other. Additionally or alternatively, in some example configurations, the second area of the objective lens assembly and the third area of the objective lens assembly are between 90-150 degrees from each other. In this position, the wrench connection portion 108 remains above the objective lens assembly 202 and axially aligned with a rotational axis 206 of the objective lens assembly 202.

Further, once the rotating arm 104 is moved to the closed position, the lock 120 can be selectively engaged with the base member 102. More particularly, in examples, the swing arm 122 of the lock 120 can engage the pin 124 on the base member 102. The lock 120 helps secure the rotating arm 104 in the closed position during use.

Once the rotating arm 104 is moved to the closed position, the only components of the tools 100 in contact with the objective lens assembly 202 are the base member engagement pads 114A, 114B, 116A, 116B and the rotating arm engagement pads 118A, 118B. In this configuration, there are three respective areas of contact of the tool 100 with the objective lens assembly 202. In this manner, contact pressure is distributed throughout the respective engagement pads.

Once the rotating arm 104 is moved to the closed position and the lock 120 is secured to the base member 102, a torque wrench 208 can engage with the wrench connection portion 108, as shown in FIG. 2C. The torque wrench 208 can then apply torque to the tool 100 via the wrench connection portion 108, rotating the tool 100 and objective lens assembly 202. Because the wrench connection portion 108 is axially aligned with a rotational axis 206 of the objective lens assembly 202, the torque wrench 208 applies torque in axial alignment with the rotational axis 206 of the objective lens assembly 202. Further, the torque wrench 208 remains in axial alignment with the rotational axis of the objective lens assembly 202 during use, which prevents misalignment of the objective lens assembly 202.

As noted above, the respective surfaces of the base member engagement pads 114A, 114B, 116A, 116B and the rotating arm engagement pads 118A, 118B each may have a coefficient of friction such that a torque value of the objective lens assembly does not exceed a maximum desired torque value. For instance, in some examples a maximum desired torque value may be between 0.5-1.5 ft-lb.

In example implementations, the tool 100 can also be utilized to remove an objective lens assembly 202 from an imaging system body 204. For instance, with the rotating arm 104 in an open position, the tool 100 can be placed on the objective lens assembly 202. The rotating arm 104 can be moved to the closed position. Once the rotating arm 104 is in the closed position, the lock 120 can secure to the rotating arm 104 to the base member 102. The drive head portion of a torque wrench 208 can engage with the wrench connection portion 108. The drive head can then be rotated in the opposition direction to unscrew the objective lens assembly from the imaging system body.

### EXAMPLE METHODS AND ASPECTS

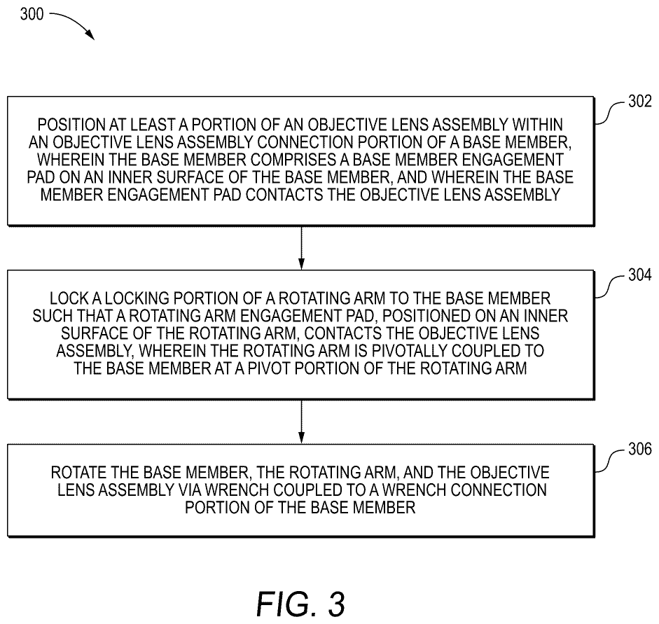

Now referring to FIG. 3, an example method of securing an objective lens to an imaging system body. Method 300 shown in FIG. 3 presents an example of a securing an objective lens assembly to an imaging system body that could utilize as example tool and/or imaging device shown in FIGS. 1A-2C, for example. Further, devices or systems may be used or configured to perform logical functions presented in FIG. 3. In other examples, components of the devices and/or systems may be arranged to be adapted to, capable of, or suited for performing the functions, such as when operated in a specific manner. Method 300 may include one or more operations, functions, or actions as illustrated by one or more of blocks 302-306. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, method 300 involves positioning at least a portion of an objective lens assembly within an objective lens assembly connection portion of a base member, wherein the base member comprises a base member engagement pad on an inner surface of the base member, and wherein the base member engagement pad contacts the objective lens assembly.

At block 304, method 300 involves locking a locking portion of a rotating arm to the base member such that a rotating arm engagement pad, positioned on an inner surface of the rotating arm, contacts the objective lens assembly, wherein the rotating arm is pivotally coupled to the base member at a pivot portion of the rotating arm.

At block 306, method 300 involves rotating the base member, the rotating arm, and the objective lens assembly via wrench coupled to a wrench connection portion of the base member. In some examples, the wrench connection portion is positioned above at least a portion of the objective lens assembly. Additionally, in some examples, the base member comprises an L-shaped member extending vertically from the objective lens assembly connection portion, wherein the wrench connection portion is positioned in a horizontal portion of the L-shaped member.

In some example implementations, while the base member, the rotating arm, and the objective lens assembly are rotating, only the base member engagement pad and the rotating arm engagement pad contact the objective lens assembly. Further, in some examples, at least at portion of the wrench connection portion is axially aligned with a rotational axis of the objective lens assembly.

In some example implementations, a surface of the base member engagement pad has a coefficient of friction such that a torque value of the objective lens assembly does not exceed 1 ft-lb. Additionally, in some examples, a surface of the rotating arm engagement pad has a coefficient of friction such that a torque value of the objective lens assembly does not exceed 1 ft-lb.

The singular forms of the articles “a, an,” and “the” include plural references unless the context clearly indicates otherwise. For example, the term “a compound” or “at least one compound”can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

1. A tool for securing an objective lens assembly to an imaging system body, the tool comprising:
a base member comprising an objective lens assembly connection portion and a wrench connection portion, wherein the wrench connection portion is configured to be coupled to a wrench;
a rotating arm pivotally coupled to the base member at a pivot portion of the rotating arm, the rotating arm comprising a locking portion selectively engageable with the base member;
a base member engagement pad on an inner surface of the base member, wherein the base member engagement pad contacts an objective lens assembly positioned at least partially within the tool; and
a rotating arm engagement pad positioned on an inner surface of the rotating arm, wherein the rotating arm engagement pad contacts the objective lens assembly positioned at least partially within the tool.

2. The tool of claim 1, wherein the wrench connection portion is positioned above at least a portion of the objective lens assembly positioned at least partially within the tool.

3. The tool of claim 1, wherein base member comprises an L-shaped member extending vertically from the objective lens assembly connection portion, wherein the wrench connection portion is positioned in a horizontal portion of the L-shaped member.

4. The tool of claim 1, wherein only the base member engagement pad and the rotating arm engagement pad contact the objective lens assembly positioned at least partially within the tool.

5. The tool of claim 1, wherein at least at portion of the wrench connection portion is axially aligned with a rotational axis of the objective lens assembly positioned at least partially within the tool.

6. The tool of claim 1, wherein rotation of the tool causes rotation of the objective lens assembly positioned at least partially within the tool, and wherein a surface of the base member engagement pad has a coefficient of friction such that a torque value of the objective lens assembly does not exceed 1 ft-lb.

7. The tool of claim 1, wherein rotation of the tool causes rotation of the objective lens assembly positioned at least partially within the tool, and wherein a surface of the rotating arm engagement pad has a coefficient of friction such that a torque value of the objective lens assembly does not exceed 1 ft-lb.

8. The tool of claim 1, wherein one of the rotating arm or the base member comprises a swing arm.

9. The tool of claim 8, wherein the other one of the rotating arm or base member comprises a pin, wherein the swing arm is selectively engageable with the pin.

10. The tool of claim 1, wherein the base member engagement pad is a first base member engagement pad, and wherein the base member comprises a second base member engagement pad on the inner surface of the base member.

11. The tool of claim 10, wherein the first base member engagement pad contacts the objective lens assembly at a first area on the objective lens assembly and the second base member engagement pad contacts the objective lens assembly at a second area on the objective lens assembly, and wherein the first area and the second area are between 90-150 degrees apart from each other.

12. The tool of claim 1, wherein the base member engagement pad comprises one or more of the following: (i) elastomers; (ii) silicone; (iii) rubber; and (iv) plastic.

13. The tool of claim 1, wherein the rotating arm engagement pad comprises one or more of the following: (i) elastomers; (ii) silicone; (iii) rubber; and (iv) plastic.

14. A method of securing an objective lens assembly to an imaging system body, the method comprising:
positioning at least a portion of an objective lens assembly within an objective lens assembly connection portion of a base member, wherein the base member comprises a base member engagement pad on an inner surface of the base member, and wherein the base member engagement pad contacts the objective lens assembly;
locking a locking portion of a rotating arm to the base member such that a rotating arm engagement pad, positioned on an inner surface of the rotating arm, contacts the objective lens assembly, wherein the rotating arm is pivotally coupled to the base member at a pivot portion of the rotating arm; and
rotating the base member, the rotating arm, and the objective lens assembly via wrench coupled to a wrench connection portion of the base member.

15. The method of claim 14, wherein the wrench connection portion is positioned above at least a portion of the objective lens assembly.

16. The method of claim 14, wherein the base member comprises an L-shaped member extending vertically from the objective lens assembly connection portion, wherein the wrench connection portion is positioned in a horizontal portion of the L-shaped member.

17. The method of claim 14, wherein, while the base member, the rotating arm, and the objective lens assembly are rotating, only the base member engagement pad and the rotating arm engagement pad contact the objective lens assembly.

18. The method of claim 14, wherein at least at portion of the wrench connection portion is axially aligned with a rotational axis of the objective lens assembly.

19. The method of claim 14, wherein a surface of the base member engagement pad has a coefficient of friction such that a torque value of the objective lens assembly does not exceed 1 ft-lb.

20. The method of claim 14, wherein a surface of the rotating arm engagement pad has a coefficient of friction such that a torque value of the objective lens assembly does not exceed 1 ft-lb.
